(19) United States
(12) Patent Application Publication
(10) Pub. No.: US 2015/0302532 A1
(43) Pub. Date: Oct. 22, 2015

(54) Advance Notification System for Projected Driver Overtime, Payroll Hours and Cost, and Other User-Defined Time Thresholds

(71) Applicant: Benjamin Dale Greene, Cassville, MO (US)

(72) Inventor: Benjamin Dale Greene, Cassville, MO (US)

(21) Appl. No.: 14/120,043

(22) Filed: Apr. 18, 2014

(51) Int. Cl. G06Q 40/00

(52) U.S. Cl. CPC G06Q 40/125

(57) ABSTRACT

An advance notification system and method that notifies management and/or other designated users of projected employee overtime, excessive payroll hours and/or other time based exceptions based on total hours or associated cost in various fields, for example drivers providing transportation services. The system generally includes a control unit to capture events in space and time such as current location, most recent activity, and the like, as they occur, consideration for cumulative actual work hours as may exist in a timekeeping system, consideration for scheduled hours as may exist in an employee work schedule in combination with wage and hour rules as might be defined by Federal, State and/or local regulations, labor agreements and/or any other user defined notification thresholds.

### CROSS REFERENCE RELATED APPLICATION NO. 61/829,648

This invention claims benefit of provisional application No. 61/829,648, filing date May 31, 2013

### BACKGROUND OF THE INVENTION

The present invention relates to data communications and information systems and, more particularly, to a notification system and methods for notifying users in advance projected overtime, payroll hours and cost and other user-defined time thresholds in various fields, such as with drivers providing transportation services.

There are many situations when it is desirable to know of a projected future hours and cost of a particular employee before the employee reaches certain cost and/or maximum hour thresholds as they relate to cost control.

Transportation service providers are required to abide by Federal, State and local wage and hour laws and other union agreements with respect to maximum drive time, meal and rest periods in addition to keeping wage and hour costs under control.

Currently transportation providers create driver schedules in a manner to avoid exceeding these thresholds. Due to unforeseen traffic delays and/or excessive load times it is common for drivers to exceed these times significantly and service providers usually are not made aware of these circumstances until well after the fact.

Other systems to prevent or minimize threshold violations rely more on short-scheduling, where a user will take the maximum number of hours and schedule the driver for a certain percentage less. For example, if the maximum hours is 8 per day, the user might schedule the driver for 7 hours. This is usually not accurate or cost effective and results in excessive deadhead times as well as the driver concerned they won't get their full 8 hour day.

These systems don't work well because on any given day there can be unforeseen delays due to traffic and/or excessive load time that dramatically affect the driver schedule, giving the user no notification as the events unfold and resulting in excessive hours and sometimes penalties and fines.

As can be seen, there is a need for an improved notification system that overcomes many of the shortfalls of conventional methods.

### BRIEF DESCRIPTION OF THE DRAWINGS

FIG. 1 is a flow chart describing a method and system according to an exemplary embodiment of the present invention;

FIG. 2 is a chart of exemplary payroll rules;

FIG. 3 is a chart of exemplary job codes in the transportation industry;

FIG. 4 is a chart of an exemplary employee schedule;

FIG. 5 is a chart showing an exemplary payroll log of an employee;

FIG. 6 is a schematic representation of a vehicle having an in-vehicle control unit;

FIG. 7 is a schematic representation of an exemplary electronic time piece;

FIG. 8 is a chart of exemplary user-defined thresholds;

FIG. 9 is a screen shot of an exemplary notification method; and

FIG. 10 is a schematic representation depicting other forms of notification methods used in the methods and systems of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an advance notification system that informs a party of projected driver overtime, payroll hours, and user-defined time thresholds. The system generally includes payroll log entries in electronic form that capture the daily work shift start time, end time, job type and rate, a system to capture the employee going on or off duty throughout the day, an electronic log of weekly hours scheduled, an electronic log of weekly hours actually worked and a global positioning system (“GPS”) used to track employee location and time. The system calculates cumulative daily payroll hours using the most recent GPS time stamp or other electronic time piece, such as a computer compared to actual, scheduled or estimated work shift start time, scheduled shift stop time and subtracting off-duty time. The system can compare hours worked by job type on previous days that week to calculate cumulative and future payroll hours and cost in terms of regular time and overtime based on local, State, and Federal wage and hour regulations and labor agreements.

The system of the present invention will notify transportation service providers in advance of drivers approaching the various thresholds related to maximum drive time and/or cost overruns giving an opportunity to adjust schedules accordingly.

Referring now to the Figures, to estimate current and future payroll regular and overtime hours and cost prior to employee shift start as well as predicted threshold violations (7), the system would calculate week-to-date actual payroll using the payroll log (4) as compared to the job codes (2), payroll rules (1) and thresholds (7) to determine the number of regular and overtime hours worked so far that week and then add in the employee schedule (3) hours for the remainder of the week and provide the user a notification of projected future hours and cost along with potential violations of the user defined thresholds via notification methods (8 and 9).

To estimate week-to-date payroll regular and overtime hours and cost after shift start time but prior to shift end time, the system would calculate week-to-date actual payroll using the payroll log (4) as compared to the job codes (2), payroll rules (1) and thresholds (7) to determine the number of regular and overtime hours worked so far that week as well as predicted threshold violations, compare the actual clock-in time to the control unit (5) activity log, electronic time piece (6) to calculate payroll hours and cost incurred so far for that particular day, subtracting any off duty time and adding in the employee schedule (3) hours for the remainder of the day and week and to provide the user a notification (8 and 9) of projected future hours and cost along with potential violations of the user defined thresholds (7).

The system loads and constantly monitors the key data sources, employee schedule (3), employee payroll log (4) and control unit (5) for changes. In the absence of change, the system will simply provide notification of calculated actual payroll to date as well as projected future payroll and user-defined threshold violations according to the collected (static) information. However, when an employee clocks-in or performs a pull-out via the control unit (5), this tells the system to begin polling for real time events that will continue to occur in the control unit (5) throughout the day until the driver completes their shift.

In transportation, a control until may be generically called a “mobile data computer” or “AVL/GPS” and the purpose is to capture events in space and time such as location, arrival and departure times, passenger boarding and deboarding, and the like, as they occur. As this device captures events by type, this data can also be used to determine the actual number of payroll hours logged by the driver as the day progresses and when aggregated to the payroll log (4) can compared to the payroll rules (1) and user-defined thresholds (7) and used to provide users advanced notification of various payroll, drive time and other cost related issues before they happen, giving the user the opportunity to adjust the driver schedule in advance. This feature will benefit both the user and the driver tremendously by saving costs and allowing driver to maximize their wages without exceeding various Federal, State and local limitations.

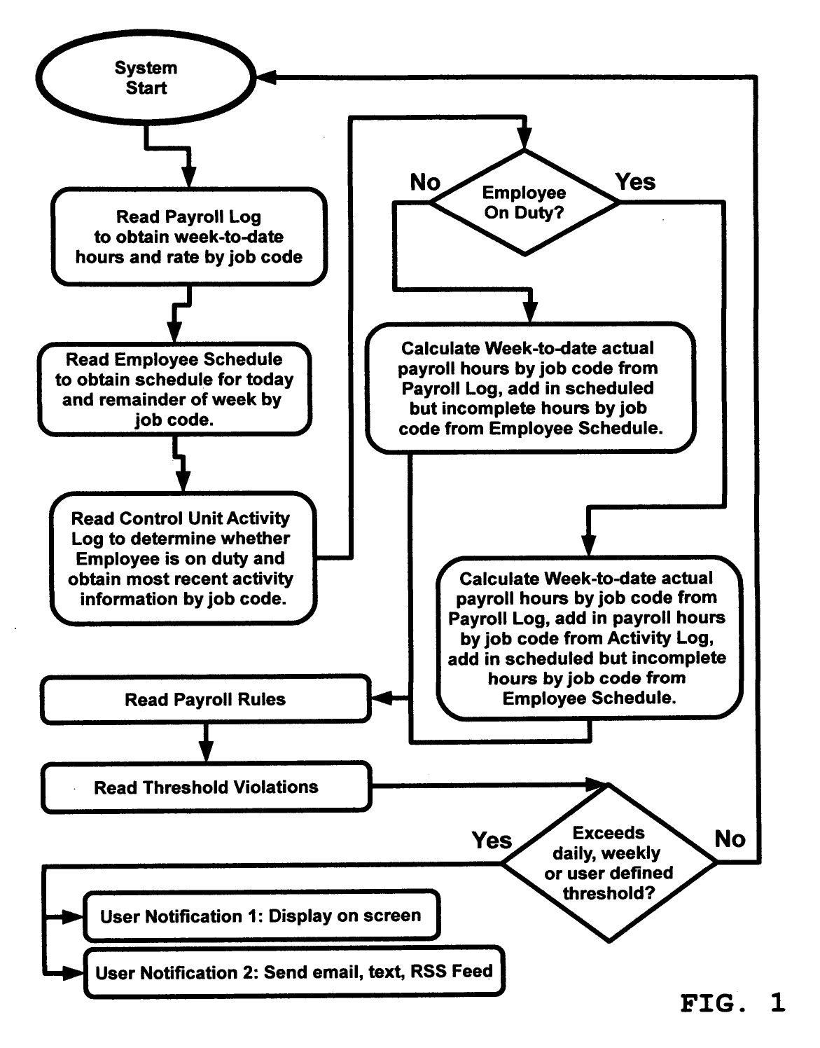

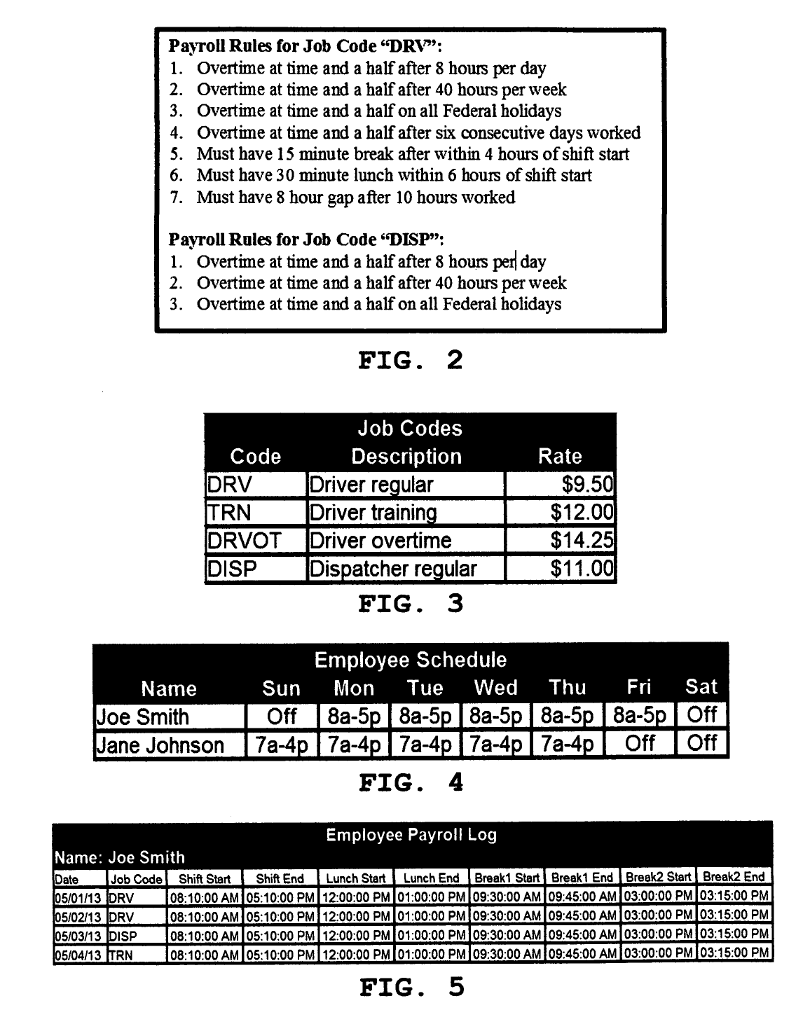

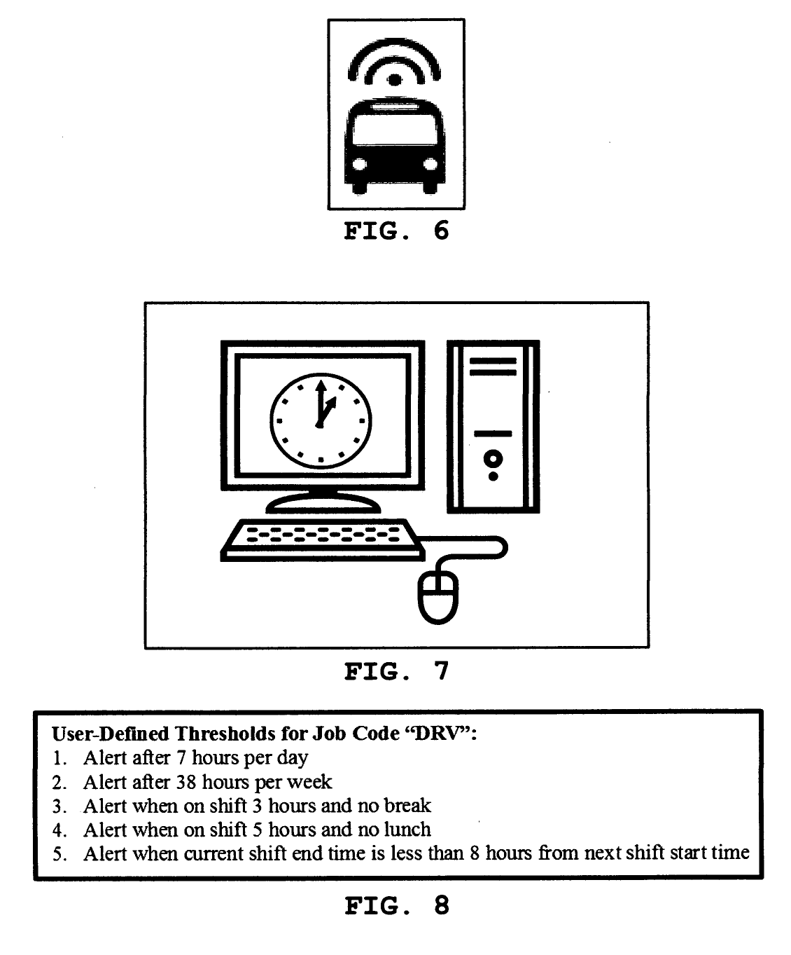

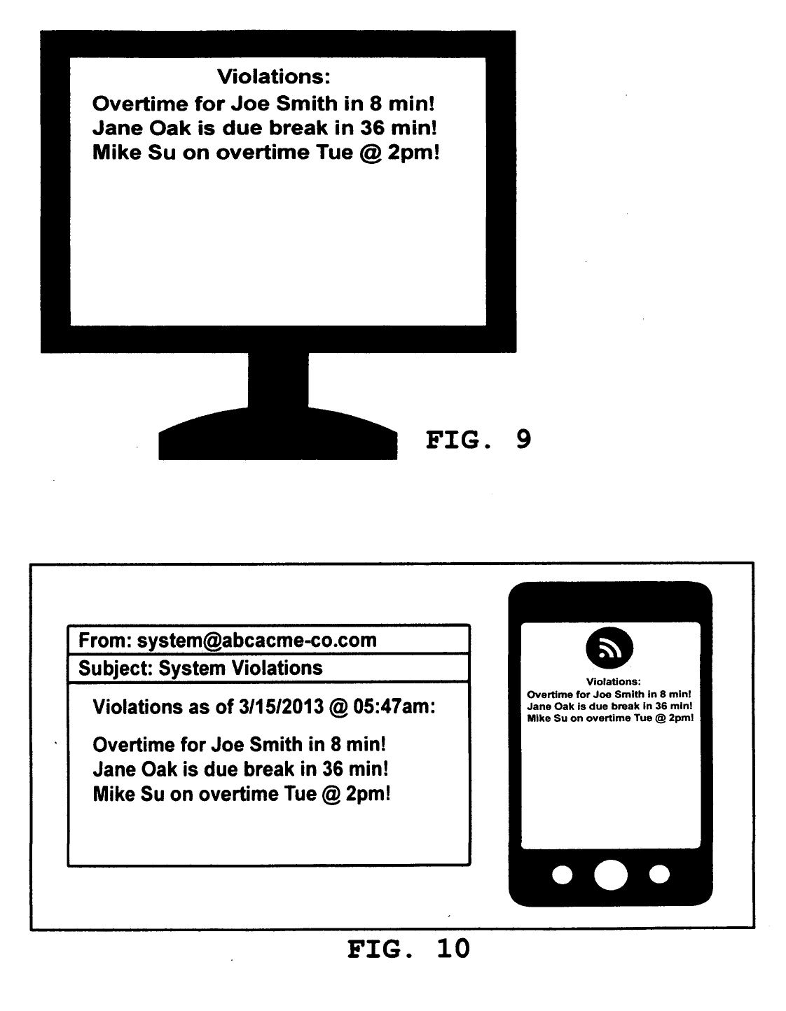

A method according to an exemplary embodiment of the present invention includes several steps, as shown in FIG. 1, for example. First the system would load the payroll log (4) to determine whether the employee is currently on-duty. If there is a clock in entry for an employee in the payroll log (4) for the current date but there is no clock out entry for the employee, the system would assume the employee is on duty.

If the employee is on duty, the system would then load data from the control unit (5) to obtain the most recent employee activity status and calculate the cumulative hours using the payroll log (4) as a start time, current local time from the electronic time piece (6) as the end time and subtracting any off duty time periods entered into the control unit (5) or payroll log (4) and compare the total hours by job code (2) to the user-defined thresholds (7) and payroll rules (1) and if the criteria is met, provide a notification via notification method 1 (8) and/or notification method 2 (9), or some other suitable form of notification system. If there has been no violation of either the user-defined threshold (7) or payroll rules (1) the system would take no action and continue to monitor.

If the employee is not on duty, the system would load the data from the payroll log (4) and employee schedule (3) to determine whether the actual hours worked week-to-date has met any of the overtime or other criteria defined in the payroll rules (1) or user-defined thresholds (7) and provide a notification via notification method 1 (8) and/or notification method 2 (9), or some other suitable form of notification system.

In some embodiments of the present invention, users might utilize a dashboard type computer display in the dispatch office that shows current payroll hours and user-defined threshold violations in various colors based on their severity. This would allow users to monitor payroll and other hour violations throughout the day and make driver schedule adjustments to prevent or minimize the violations. In other embodiments of the present invention, users might also subscribe to an automated alert for pending violations via email, text message and/or RSS/Web feed to become aware of potential violations in advance giving time to make adjustments to driver schedules.

While the above describes the system and method used in the transportation industry, in addition to the transportation field, the methods and system of the present invention could be used to provide advance notification of payroll costs and/or work time violations for any type of employee in any industry.

What is claimed is:

1. A method, comprising:
monitoring travel data associated with an employee;
comparing planned timing of the employee to updated employee status information;
contacting a user communications device before the employee reaches a the overtime threshold; and
informing a user of an estimated cost associated with cumulative and projected regular and overtime rate, based upon the updated employee status information and the planned timing.

2. A system, comprising:
means for monitoring travel data associated with an employee;
means for comparing planned timing of an employee to updated employee status information;
means for contacting a user communications device before the employee reaches a certain user-defined threshold such as the point at which the employee will reach overtime rate and/or as at points prior to that; and
informing a user of an estimated cost associated with cumulative and projected regular and overtime rate, based upon the updated employee status information and the planned timing.
